(19) United States
(12) Patent Application Publication
(10) Pub. No.: US 2007/0101404 A1
(43) Pub. Date: May 3, 2007

(54) Network relay method, network relay device, communication controller, and computer product

(75) Inventors: Yoshiki Higashikado, Kawasaki (JP); Masashi Mitomo, Kawasaki (JP); Masahiro Komura, Kawasaki (JP); Bintatsu Noda, Kawasaki (JP); Kazumasa Omote, Kawasaki (JP); Satoru Torii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/368,429

(22) Filed: Mar. 7, 2006

(30) Foreign Application Priority Data
Oct. 27, 2005 (JP) 2005-313345

(51) Int. Cl. H04L 9/32

(52) U.S. Cl. 726/3

(57) ABSTRACT

In a network relay device, unauthorized access from an internal computer to an external network is detected, an unauthorized destination service port used for the unauthorized access is specified, and a substitute port is allocated. A service relay unit and the internal computer are instructed to use the substitute port instead of the unauthorized destination service port, and an unauthorized access notification is sent. Mutual conversion of the unauthorized destination service port and a substitute service port is carried out, to relay a packet between an internal network and the external network.

### BACKGROUND OF THE INVENTION

1. Field of the Invention

The present invention relates to a network relay method and a network relay device that relay communication between an internal network and an external network, a communication controller that controls the communication, and a computer product.

2. Description of the Related Art

Conventionally in a company, upon detection of unauthorized access to an external network by an internal computer connected to an internal network due to infection by a worm etc., the infected computer is disconnected from the internal network to prevent escalation of damage.

Japanese Patent Laid-Open Publication No 2002-73433 discloses an intrusion detecting device that identifies a service port used for the unauthorized access, blocks the service port, and instructs a modification to a substitute port, upon detecting the unauthorized access to the external network by the internal computer connected to the internal network.

FIG. 12 is a diagram of a conventional computer network system that uses the intrusion detecting device. As shown in FIG. 12, the computer network system includes an intrusion detecting device 800 and a computer 810 that are connected to the internal network of the company, an application server 830 that is connected to the external network, and a network relay device 820 that relays communication between the internal network and the external network.

In the computer network system, upon detecting the unauthorized access from the internal network to the application server 830, an unauthorized intrusion monitoring unit 804 of the intrusion detecting device 800 identifies a destination service port that is used for the unauthorized intrusion, and instructs a port blocking unit 821 of the network relay device 820 via a countermeasure unit 803 to block the destination service port. The port blocking unit 821 blocks the destination service port (port A) that is used for the unauthorized access, and simultaneously, a temporary port allocating unit 822 allocates a port B as a substitute port.

The temporary port allocating unit 822 notifies an application port instructing unit 811 of the computer 810 that the port A is blocked due to detection of the unauthorized access and that the port B is allocated as the substitute port.

Because the originally used port A is blocked, an application program 812 in the computer 810 follows an instruction by the application port instructing unit 811 pertaining to a temporary port allocating table, and by using the port B, carries out communication with the application server 830 via the network relay device 820. During communication, a Web server program 831 on the application server 830 is notified of the modification pertaining to service port that is notified from the intrusion detecting device 800 to an application port instructing unit 833, and the Web server program 831 waits at the notified service port, thereby enabling the application program 812 of the computer 810 to carry out communication with the Web server program 831.

However, the conventional method requires matching the destination service ports of all the applications that carry out communication, in addition to ensuring that the same temporary destination service ports are opened by all the network devices that carry out relay. Satisfying these conditions in a wide network is difficult. Moreover, due to matching of the destination service ports of the applications, a longer time is required to transmit data to other computers connected to the external network and the internal network, thereby resulting in slowing of communication.

### SUMMARY OF THE INVENTION

It is an object of the present invention to at least solve the problems in the conventional technology.

According to one aspect of the present invention, a network relay method that relays communication between an internal network and an external network, includes fetching an unauthorized communication identifier used for communication by an unauthorized program that transmits unauthorized data from the internal network to the external network; and controlling relay of data communication between the internal network and the external network based on fetched unauthorized communication identifier, after transmission of unauthorized data by the unauthorized program has been detected.

According to still another aspect of the present invention, a computer-readable recording medium that records thereon a computer program that relays communication between an internal network and an external network, the computer program including instructions which, when executed, cause a computer to execute the above method.

According to another aspect of the present invention, a method for communication control includes fetching an unauthorized destination identifier used by an unauthorized program as destination in data communication, and a substitute destination identifier that is used instead of the unauthorized destination identifier by an internal computer connected to an internal network to transmit data to an external network, after transmission of unauthorized data by the unauthorized program is detected; and converting the unauthorized destination identifier to the substitute destination identifier, if data that uses the unauthorized destination identifier as destination is received from an application program.

According to still another aspect of the present invention, a computer-readable recording medium that records thereon a computer program for communication control, the computer program including instructions which, when executed, cause a computer to execute the above method.

According to still another aspect of the present invention, a network relay device that relays communication between an internal network and an external network, includes an unauthorized communication identifier fetching unit that fetches an unauthorized communication identifier used for communication by an unauthorized program that transmits unauthorized data from the internal network to the external network; and a communication data relay controller that controls relay of data communication between the internal network and the external network based on fetched unauthorized communication identifier, after transmission of unauthorized data by the unauthorized program has been detected.

According to still another aspect of the present invention, a communication controller includes an unauthorized destination identifier fetching unit that fetches an unauthorized destination identifier used by an unauthorized program as destination in data communication, and a substitute destination identifier that is used instead of the unauthorized destination identifier by an internal computer connected to an internal network to transmit data to an external network, after transmission of unauthorized data by the unauthorized program is detected; and a destination identifier converter that converts the unauthorized destination identifier to the substitute destination identifier, if data that uses the unauthorized destination identifier as destination is received from an application program.

According to still another aspect of the present invention, a network relay device that relays communication between an internal network and an external network, includes a detecting unit that detects if an unauthorized access program is communicating unauthorized data through the network; and a relay controlling unit that blocks transmission of data to and from the unauthorized access program, and that allows transmission of other data, between the internal network and the external network.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a computer network system according to a first embodiment;

FIG. 2 is a drawing illustrating an example of an unauthorized access monitoring table;

FIG. 3 is a flowchart of a process executed by an unauthorized access detecting unit of a network relay device;

FIG. 4 is a flowchart of a process executed by a service relay unit of the network relay device;

FIG. 5 is a flowchart of a port mapping process executed by an uninfected computer;

FIG. 6 is a flowchart of the port mapping process executed by an infected computer;

FIG. 7 is a flowchart of a process-terminating procedure executed by a process controller of the infected computer;

FIG. 8 is a functional block diagram of a computer network system according to a second embodiment;

FIG. 9 is an example of a relay permission table;

FIG. 10 is a flowchart of a process executed by the service relay unit of the network relay device according to the second embodiment;

FIG. 11 is a functional block diagram of a computer that executes a network relay program according to the first and the second embodiments; and

FIG. 12 is a diagram of a conventional computer network system.

### DETAILED DESCRIPTION OF THE PREFERRED EMBODIMENTS

Exemplary embodiments of the present invention are explained in detail below with reference to the accompanying drawings.

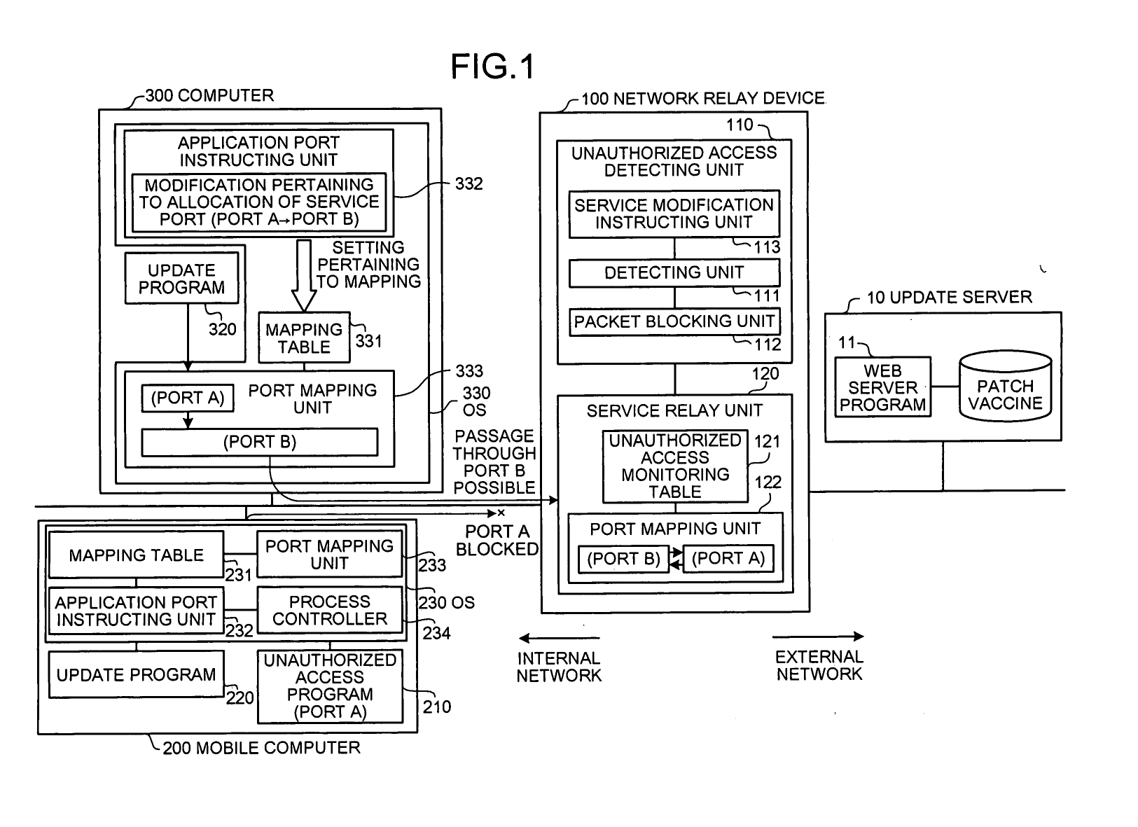

A structure of a computer network system according to a first embodiment is explained first. FIG. 1 is a functional block diagram of the computer network system according to the first embodiment. As shown in FIG. 1, the computer network system includes a mobile computer 200 and a computer 300 that are connected to an internal network of the company, an update server 10 that is connected to an external network, and a network relay device 100 that relays communication between the internal network and the external network.

Before being connected to the internal network, the mobile computer 200 has been infected, in another network, with a worm that spreads infection through a port A as a Transmission Control Protocol (TCP) destination service port. The worm transmits a random infection packet called random scan to spread infection through the port A as the destination service port. For the sake of convenience, a single computer 300 is shown in FIG. 1. However, other computers are also connected to the internal network and the external network.

The network relay device 100 includes an unauthorized access detecting unit 110 and a service relay unit 120. The unauthorized access detecting unit 110 detects an unauthorized packet that is transmitted from a computer connected to the internal network (hereinafter, “internal computer”) to the external network, blocks the unauthorized packet, and instructs a modification of the destination service port (port A in the example shown in FIG. 1) that is used by the unauthorized packet. The unauthorized access detecting unit 110 includes a detecting unit 111, a packet blocking unit 112, and a service modification instructing unit 113.

The detecting unit 111 monitors a packet that is transmitted from the internal computer to the external network, detects an unauthorized packet such as an infected packet, and specifies an Internet Protocol (IP) address of the computer that transmitted the unauthorized packet, and a source service port, a destination service port, and a protocol of the unauthorized packet, thereby notifying the packet blocking unit 112 and the service modification instructing unit 113 of the unauthorized packet.

The packet blocking unit 112 fetches data such as the destination service port etc. of the unauthorized packet from the detecting unit 111 and blocks the packet that is transmitted to the external network by using the fetched destination service port as a destination service port.

The service modification instructing unit 113 fetches from the detecting unit 111, data such as the IP address of the computer that transmitted the unauthorized packet, the source service port, the destination service port, and the protocol of the unauthorized packet, and allocates a substitute port for the fetched destination service port (port B in the example shown in FIG. 1). Further, the service modification instructing unit 113 transmits data such as the IP address of the computer that transmitted the unauthorized packet, the source service port, the destination service port, the substitute port, and the protocol etc. of the unauthorized packet to the service relay unit 120 and the internal computer as an unauthorized access notification, and instructs modification of the destination service port to the substitute port.

The service relay unit 120 relays a packet between the internal network and the external network, and includes an unauthorized access monitoring table 121 and a port mapping unit 122.

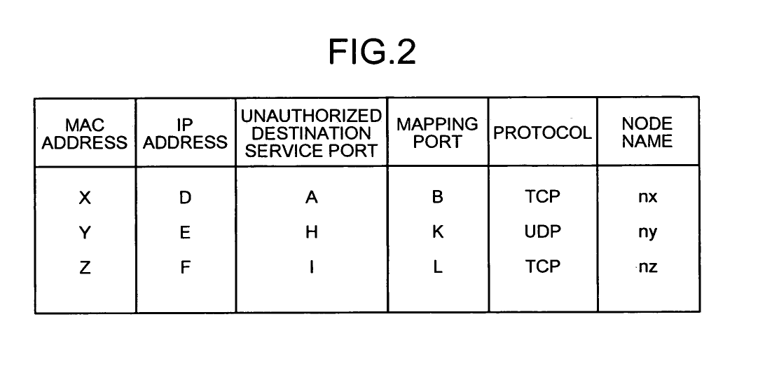

The unauthorized access monitoring table 121 stores data related to the destination service port, the substitute port etc. of the unauthorized packet that is detected by the unauthorized access detecting unit 110. FIG. 2 is a drawing illustrating an example of the unauthorized access monitoring table 121.

As shown in FIG. 2, the unauthorized access monitoring table 121 stores for every unauthorized access, a Media Access Control (MAC) address and the IP address of the computer that transmitted the unauthorized packet, an unauthorized destination service port that is the destination service port of the unauthorized packet, a mapping port that is the substitute port, the protocol used during the unauthorized access, and a node name of the computer that transmitted the unauthorized packet.

The port mapping unit 122 fetches from the service modification instructing unit 113 data such as the destination service port that is used for the unauthorized access and the substitute port, stores the fetched data in the unauthorized access monitoring table 121, and by using the unauthorized access monitoring table 121, carries out a conversion between the destination service port that is used for the unauthorized access and the substitute port.

In other words, among the packets that are transmitted from the internal network, for the packets having the destination service ports that are the mapping ports in the unauthorized access monitoring table 121, the port mapping unit 122 modifies the respective destination service ports to the unauthorized destination service ports in the unauthorized access monitoring table 121, and the packets are transmitted to the external network. Further, among the packets that are transmitted from the external network, for the packets having the source service ports that are the unauthorized destination service ports in the unauthorized access monitoring table 121, the respective source service ports are modified by the port mapping unit 122 to the mapping ports of the unauthorized access monitoring table 121, and the packets are transmitted to the internal network.

By using the unauthorized access monitoring table 121, the port mapping unit 122 carries out the conversion between the destination service port that is used by the unauthorized packet and the substitute port, thereby enabling to carry out communication in the internal network using the substitute port, and enabling to carry out communication in the external network using the destination service port that is used by the unauthorized packet. As shown in FIG. 1, the port mapping unit 122 converts the port B that is used in the internal network and the port A that is used in the external network.

The mobile computer 200 executes an unauthorized access program 210, an update program 220, and an Operating System (OS) 230. The OS 230 includes a mapping table 231, an application port instructing unit 232, a port mapping unit 233, and a process controller 234.

The unauthorized access program 210 carries out an unauthorized access by using the port A as the destination service port. The unauthorized access detecting unit 110 detects the unauthorized packet that is transmitted by the unauthorized access program 210 and allocates the port B as the substitute port.

The update program 220 gets a vaccine program and a patch from the update server 10, removes the infected worm, and applies the patch. Because the update server 10 provides the vaccine program and the patch by using the port A as the destination service port, the update program 220 uses the port A as the destination service port when getting the vaccine program and the patch.

The mapping table 231 stores the destination service port and the substitute port of the unauthorized packet that is detected by the unauthorized access detecting unit 110.

The application port instructing unit 232 fetches from the service modification instructing unit 113 of the network relay device 100, data such as the destination service port that is used for the unauthorized access and the substitute port etc. as the unauthorized access notification, distributes the unauthorized access notification to the process controller 234, and stores the data such as the destination service port that is used for the unauthorized access and the substitute port in the mapping table 231.

The port mapping unit 233 carries out the conversion between the destination service port that is used by the unauthorized packet and the substitute port by using the mapping table 231. In other words, among the packets which are transmitted to the external network by the applications that are executed by the mobile computer 200, if the destination service ports of the packets are recorded in the mapping table 231 as service ports used by the unauthorized packet, the port mapping unit 233 exchanges the destination service ports of such packets for the substitute ports and transmits the packets to the network relay device 100. Further, among the packets that are transmitted from the network relay device 100, if the source service ports of packets are recorded in the mapping table 231 as the substitute ports, the port mapping unit 233 reverts the source service ports of such packets to the service ports that are used by the unauthorized packet and transmits the packets to the application program.

The network relay device 100 blocks a packet that uses the port A as the destination service port. However, the port mapping unit 233 converts the port A into the port B, and the port mapping unit 122 of the network relay device 100 converts the port B into the port A, thereby enabling the update program 220 to get the vaccine program and the patch from the update server 10 by using the port A.

The mapping table 231, the application port instructing unit 232, and the port mapping unit 233 form a part of a communication control program that controls communication in the OS 230.

The process controller 234 controls the processes that are executed by the mobile computer 200. The process controller 234 receives the unauthorized access notification from the service modification instructing unit 113 of the network relay device 100 via the application port instructing unit 232, specifies a process of the program that is carrying out the unauthorized access, and terminates the process.

The computer 300 executes an update program 320 and an OS 330. The OS 330 includes a mapping table 331, an application port instructing unit 332, and a port mapping unit 333.

The update program 320 accesses the update server 10 by using the port A.

The mapping table 331 stores the destination service port of the unauthorized packet that is detected by the unauthorized access detecting unit 110 and the substitute port.

The application port instructing unit 332 fetches from the service modification instructing unit 113 of the network relay device 100, data such as the destination service port that is used for the unauthorized access and the substitute port etc. as the unauthorized access notification, and stores the fetched data in the mapping table 331.

The port mapping unit 333 carries out the conversion between the destination service port that is used by the unauthorized packet and the substitute port by using the mapping table 331. In other words, among the packets which are transmitted to the external network by the applications that are executed by the computer 300, if the destination service ports of the packets are recorded in the mapping table 331 as service ports used by the unauthorized packet, the port mapping unit 333 modifies the destination service ports of such packets to the substitute ports and transmits the packets to the network relay device 100. Further, among the packets that are transmitted from the network relay device 100, if the source service ports of packets are recorded in the mapping table 331 as the substitute ports, the port mapping unit 333 reverts the source service ports of such packets to the service ports that are used by the unauthorized packet and transmits the packets to the application program.

The mapping table 331, the application port instructing unit 332, and the port mapping unit 333 form a part of a communication control program that controls communication in the OS 330.

The update server 10 executes a Web server program 11. The Web server program 11 provides the vaccine program and the patch by using the port A as the service port.

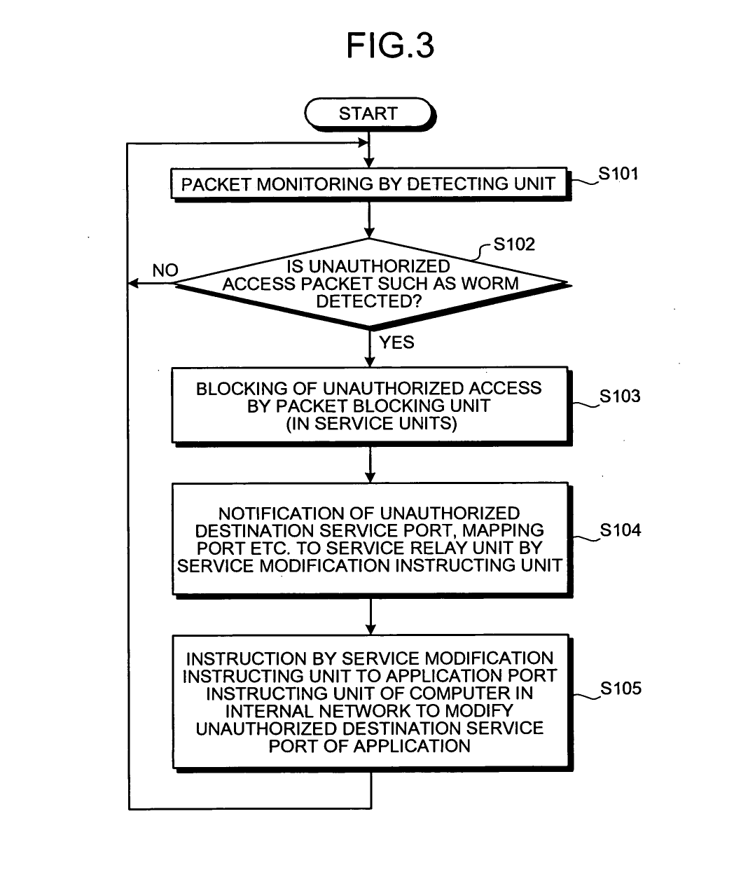

A sequence of a process by the unauthorized access detecting unit 110 of the network relay device 100 is explained next. FIG. 3 is a flowchart of the process executed by the unauthorized access detecting unit 110 of the network relay device 100.

As shown in FIG. 3, the detecting unit 111 of the unauthorized access detecting unit 110 monitors packets (step S101), and upon detecting an unauthorized access packet such as a worm (“Yes” at step S102), the packet blocking unit 112 blocks the packet that carries out the unauthorized access (step S103). Blocking of the packet is carried out in service units.

The service modification instructing unit 113 notifies the service relay unit 120 of data such as the unauthorized destination service port that is used by the unauthorized packet, and the mapping port that is the substitute port (step S104).

The service modification instructing unit 113 transmits, to the application port instructing units of the mobile computer 200 and the computer 300 that are connected to the internal network, an unauthorized access notification that includes data such as the IP address of the computer that transmitted the unauthorized packet, the source service port of the unauthorized packet, the unauthorized destination service port, the substitute port, the protocol etc., and instructs a modification of the unauthorized destination service port of the application (step S105). In other words, the service modification instructing unit 113 instructs that the destination service ports of the applications that use the destination service ports of the unauthorized packet as destinations be modified to the mapping ports.

Thus, when the detecting unit 111 detects the unauthorized access packet, the packet blocking unit 112 blocks the unauthorized access packet, and the service modification instructing unit 113 notifies the service relay unit 120 and the internal computer of data that includes the unauthorized destination service port that is used by the unauthorized packet and the substitute port, thereby enabling to carry out communication in the external network using the unauthorized destination service port and enabling to carry out communication in the internal network using the substitute port.

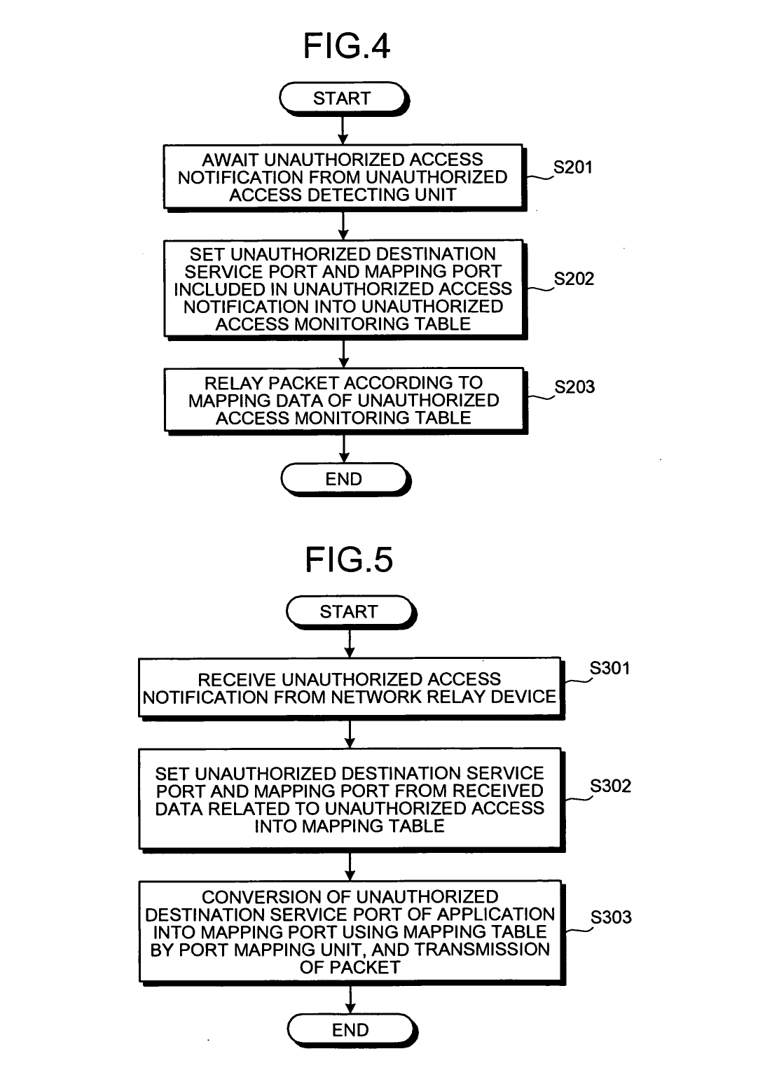

A sequence of a process executed by the service relay unit 120 of the network relay device 100 is explained next. FIG. 4 is a flowchart of the process executed by the service relay unit 120 of the network relay device 100.

As shown in FIG. 4, the service relay unit 120 awaits the unauthorized access notification from the unauthorized access detecting unit 110 (step S201). Upon fetching the unauthorized access notification, the port mapping unit 122 sets data such as the unauthorized destination service port, the mapping port etc. in the unauthorized access monitoring table 121 from the data included in the unauthorized access notification (step S202).

The port mapping unit 122 relays the packet in accordance with the mapping data of the unauthorized access monitoring table 121 (step S203). In other words, among the packets that are transmitted from the internal network, if the destination service ports of the packets are the mapping ports of the unauthorized access monitoring table 121, the destination service ports of such packets are reverted by the port mapping unit 122 to the unauthorized destination service ports of the unauthorized access monitoring table 121, and the packets are transmitted to the external network. Further, among the packets that are transmitted from the external network, if the source service ports of the packets are the unauthorized destination service ports of the unauthorized access monitoring table 121, the source service ports of such packets are modified by the port mapping unit 122 to the mapping ports of the unauthorized access monitoring table 121, and the packets are transmitted to the internal network.

Thus, the port mapping unit 122 carries out the conversion between the destination service ports that are used by the unauthorized packet and the mapping ports in accordance with the mapping data of the unauthorized access monitoring table 121 and blocks the packet, thereby enabling to carry out communication in the internal network using the mapping ports and enabling to carry out communication in the external network using the unauthorized destination service ports.

Next, a sequence of a port mapping process executed by the uninfected computer 300 is explained next. FIG. 5 is a flowchart of the port mapping process executed by the uninfected computer 300.

As shown in FIG. 5, the application port instructing unit 332 of the uninfected computer 300 receives the unauthorized access notification from the network relay device 100 (step S301), and sets into the mapping table 331 the unauthorized destination service port and the mapping port from the received data related to the unauthorized access (step S302).

Next, by using the mapping table 331, the port mapping unit 333 converts the unauthorized destination service port of the application into the mapping port, and transmits the packet (step S303).

Thus, by using the mapping table 331, the port mapping unit 333 converts the unauthorized destination service port of the application into the mapping port, and transmits the packet, thereby enabling the application that runs in the uninfected computer 300 to communicate with the external network by using the unauthorized destination service port.

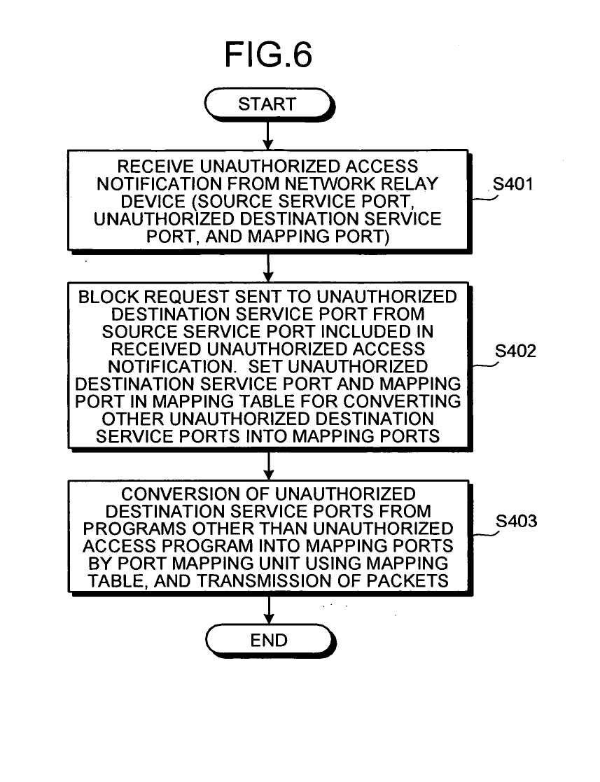

A sequence of a port mapping process executed by the infected computer (mobile computer) 200 is explained next. FIG. 6 is a flowchart of the port mapping process executed by the mobile computer 200.

As shown in FIG. 6, the application port instructing unit 232 of the infected computer 200 receives from the network relay device 100 the unauthorized access notification that includes data such as the source service port, the unauthorized destination service port, and the mapping port of the unauthorized packet (step S401). The application port instructing unit 232 blocks a request from the source service port that is included in the received unauthorized access notification to the unauthorized destination service port, and sets the unauthorized destination service port and the mapping port in the mapping table 231 for converting other unauthorized destination service ports into the mapping ports (step S402).

By using the mapping table 231, the port mapping unit 233 converts into the mapping ports the unauthorized destination serving ports of the packets that are transmitted from programs other than the unauthorized access program 210, and transmits the packets (step S403).

Thus, by using the mapping table 231, the port mapping unit 233 converts into the mapping ports the unauthorized destination serving ports of the packets that are transmitted from programs other than the unauthorized access program 210, and transmits the packets, thereby enabling the applications other than the unauthorized access program 210 that run in the infected computer 200 to communicate with the external network by using the unauthorized destination service port.

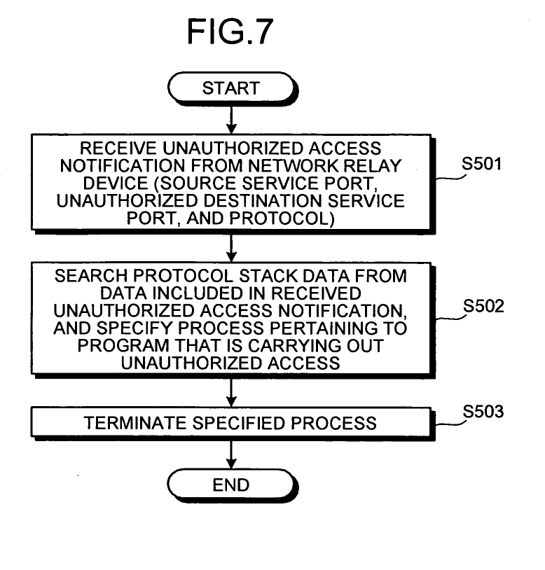

A sequence of a process-terminating procedure executed by the process controller 234 of the infected computer (mobile computer) 200 is explained next. FIG. 7 is a flowchart of the process-terminating procedure executed by the process controller 234 of the infected computer 200.

As shown in FIG. 7, the process controller 234 of the infected computer 200 receives from the network relay device 100, via the application port instructing unit 232, the unauthorized access notification that includes data such as the source service port, the unauthorized destination service port and the protocol (step S501).

The process controller 234 searches protocol stack data from the data included in the received unauthorized access notification, and specifies a process of the program that is carrying out the unauthorized access (step S502). Next, the process controller 234 terminates the specified process (step S503).

Thus, based on data that is included in the unauthorized access notification, the process controller 234 of the infected computer 200 specifies the process of the program that carries out the unauthorized access and terminates the process, thereby enabling to terminate transmission of the unauthorized packet.

In the first embodiment, the unauthorized access detecting unit 110 of the network relay device 100 detects an unauthorized access from an internal computer to the external network, specifies the unauthorized destination service port that is used for the unauthorized access, allocates the substitute port, instructs the service relay unit 120 and the internal computers to use the substitute port instead of using the unauthorized destination service port, and transmits the unauthorized access notification. The application port instructing units of the internal computers that receives the unauthorized access notification set data such as the unauthorized destination service port and the substitute port in the mapping tables. When transmitting the packet to the external network, the port mapping units use the mapping tables to convert the unauthorized destination service port into the substitute port. The service relay unit 120 sets in the unauthorized access monitoring table 121 data such as the unauthorized destination service port and the substitute port included in the unauthorized access notification, and when relaying the packet between the internal network and the external network, uses the unauthorized access monitoring table 121 to carry out a mutual conversion between the unauthorized service port and the substitute port, thereby enabling to carry out communication in the internal network using the substitute port and enabling to carry out communication in the external network using the unauthorized destination service port.

The network relay device 100, which detects the unauthorized access and carries out service modification, in other words, instructs the internal computers to modify the unauthorized destination service port to the substitute port is explained in the first embodiment. However, the present invention is not to be thus limited, and can similarly be applied to a network relay device in which a function to detect the unauthorized access and a function to instruct service modification are provided in the form of separate devices.

The network relay device 100, which is explained in the first embodiment, specifies the unauthorized destination service port that is used for unauthorized access by the unauthorized access program, and modifies at the OS level, the unauthorized destination service ports that are used by other programs to the substitute ports to carry out communication in the internal network. When relaying the packet between the internal network and the external network, the network relay device 100 carries out a mutual conversion between the unauthorized destination service port and the substitute port, thereby enabling the other programs to continuously use the unauthorized destination service port. However, the other programs can also use the unauthorized destination service port without using the substitute port. A network relay device, which is explained in a second embodiment, enables the other programs to continuously use the unauthorized destination service port without using the substitute port.

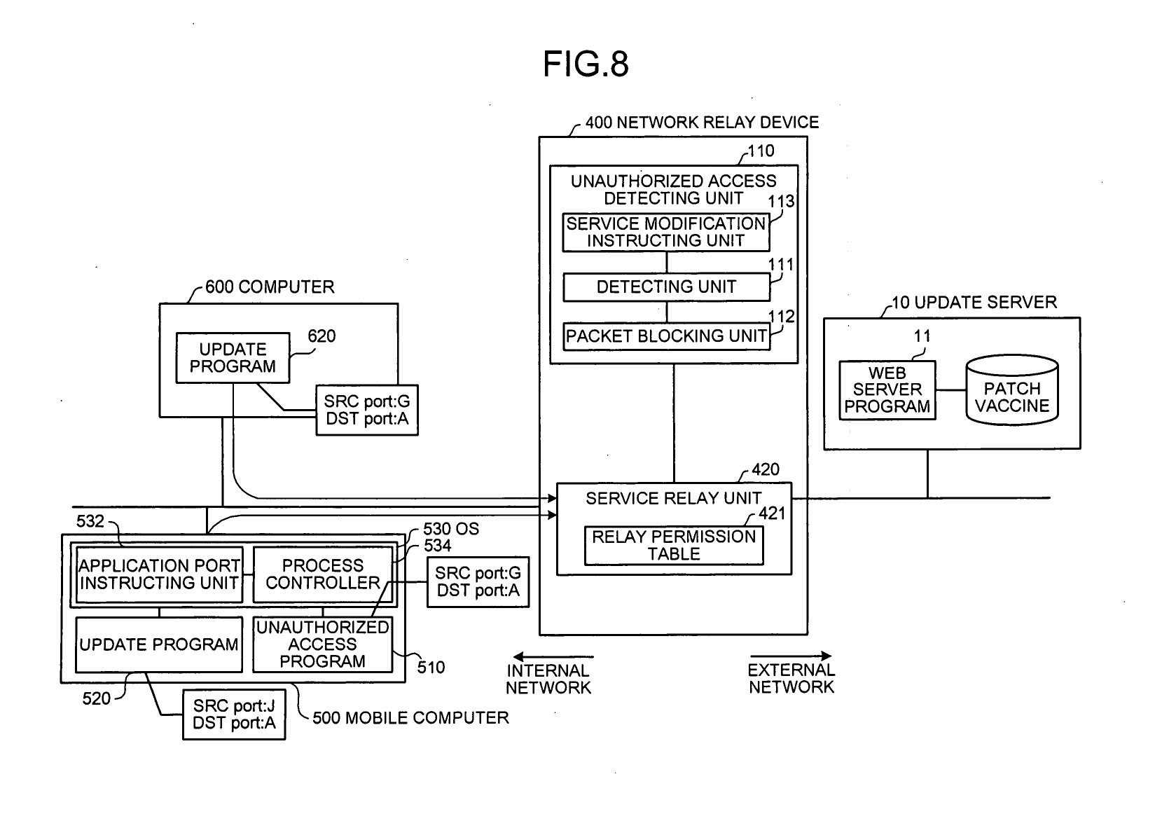

A structure of a computer network system according to the second embodiment is explained first. FIG. 8 is a functional block diagram of the computer network system according to the second embodiment. For the sake of convenience, units performing similar functions as the units shown in FIG. 1 are indicated by the same reference numerals, and the detailed explanation is omitted.

As shown in FIG. 8, the computer network system includes a mobile computer 500 and a computer 600 that are connected to the internal network of the company, the update server 10 that is connected to the external network, and a network relay device 400 that relays communication between the internal network and the external network.

Before being connected to the internal network, the mobile computer 500 has been infected in another network with a worm that spreads infection through the port A as a TCP destination service port. An unauthorized access program 510 that runs in the mobile computer 500 carries out an unauthorized access by using the port A as the destination service port and using a port G as a source service port.

The mobile computer 500 runs an update program 520 for fetching the vaccine program and the patch from the update server 10. The update program 520 carries out communication with the update server 10 by using the port A as the destination service port and a port J as the source service port. The computer 600 runs an update program 620 for fetching the vaccine program and the patch from the update server 10. The update program 620 carries out communication with the update server 10 by using the port A as the destination service port and the port G as the source service port.

The network relay device 400 includes the unauthorized access detecting unit 110 and a service relay unit 420. The service relay unit 420 relays the packet between the internal network and the external network, and further includes a relay permission table 421. The relay permission table 421 stores data related to permission or prohibition of relay.

The service relay unit 420 receives from the unauthorized access detecting unit 110, data such as the IP address of the computer that transmitted the unauthorized packet, the source service port that is used by the unauthorized packet etc. in the form of the unauthorized access notification, and records the received data in the relay permission table 421 for determining whether to permit relay. The service relay unit 420 relays a packet only if a relay permission pertaining to the packet is recorded in the relay permission table 421.

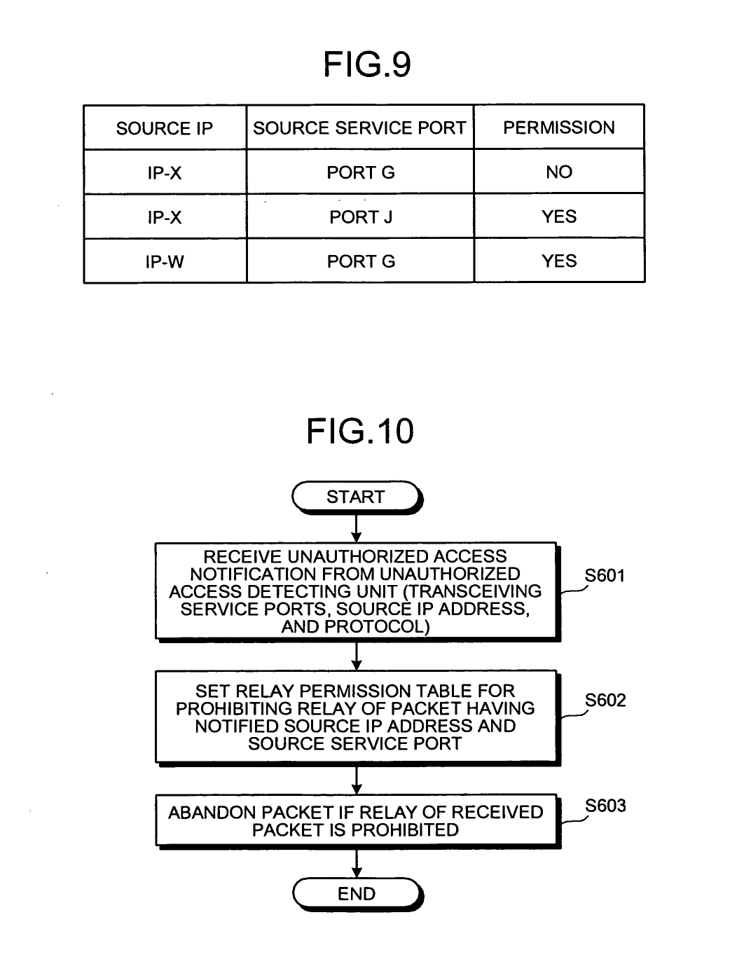

FIG. 9 is an example of the relay permission table 421. As shown in FIG. 9, the relay permission table 421 stores, for every application that runs in the internal computer and carries out communication with the external network, a source IP that is the IP address of the internal computer, the destination service port, and data pertaining to whether communication of the application is permitted.

As shown in FIG. 9, a computer having the source IP IIIP-XII corresponds to the mobile computer 500 shown in FIG. 8, and the unauthorized access program 510 that runs in the mobile computer 500 carries out an unauthorized access by using the port G as the source service port. Thus, communication pertaining to the unauthorized access program 510 that runs in the mobile computer 500 having the source IP “IP-X” and uses the port G as the source service port is prohibited (NO).

The update program 520 that runs in the mobile computer 500 uses the port J as the source service port to access the update server 10. Thus, communication pertaining to the update program 520 that runs in the mobile computer 500 having the source IP “IP-X” and uses the port J as the source service port is permitted (YES).

As shown in FIG. 9, a computer having the source IP “IP-W” corresponds to the computer 600 shown in FIG. 8, and the update program 620 that runs in the computer 600 accesses the update server 10 by using the port G as the source service port. Thus, communication pertaining to the update program 620 that runs in the computer 600 having the source IP “IP-W” and uses the port G as the source service port is permitted (YES).

Thus, the service relay unit 420 relays a packet only if a relay permission pertaining to the packet is recorded in the relay permission table 421, thereby enabling to block only the packet that is transmitted by the unauthorized access program 510.

An OS 530 that runs in the mobile computer 500 includes an application port instructing unit 532 and a process controller 534. The application port instructing unit 532 receives from the unauthorized access detecting unit 110 of the network relay device 400 the unauthorized access notification that includes data such as a source service protocol, a destination service protocol, a protocol etc. that are used for the unauthorized access, and distributes the received unauthorized access notification to the process controller 534. Based on the fetched data such as the source service protocol, the destination service protocol, and the protocol, the process controller 534 specifies the process that is carrying out the unauthorized access, and terminates the process.

A sequence of a process executed by the service relay unit 420 of the network relay device 400 according to the second embodiment is explained next. FIG. 10 is a flowchart of the process executed by the service relay unit 420 of the network relay device 400 according to the second embodiment.

As shown in FIG. 10, the service relay unit 420 receives from the unauthorized access detecting unit 110 the unauthorized access notification that includes data such as the transceiving service ports of the unauthorized packet, the source IP address, the protocol etc. (step S601), and sets the relay permission table 421 for prohibiting relay of the packet having the source IP address and the source service port that are included in the unauthorized access notification (step S602).

Upon receiving a packet such that relay of the packet is prohibited according to the relay permission table 421, the service relay unit 420 abandons the packet (step S603). In other words, based on the IP address of the internal computer that transmits the packet and the source service port, the service relay unit 420 determines whether to transmit the packet to the external network.

Thus, the service relay unit 420 relays the packet by using the relay permission table 421, thereby enabling to prevent transmission of the unauthorized packet to the external network.

Thus, in the second embodiment, the service relay unit 420 of the network relay device 400 stores the IP address and the service port of the unauthorized packet in the relay permission table 421 for determining whether to permit relay, and uses the relay permission table 421 to determine whether to relay a packet that is transmitted from the internal computer to the external network, thereby enabling other applications to continue using the destination service port that is used for the unauthorized access.

A network relay device is explained in the first and the second embodiments. However, the network relay device can be realized by using software as a network relay program that includes similar functions. A computer that executes the network relay program is explained next.

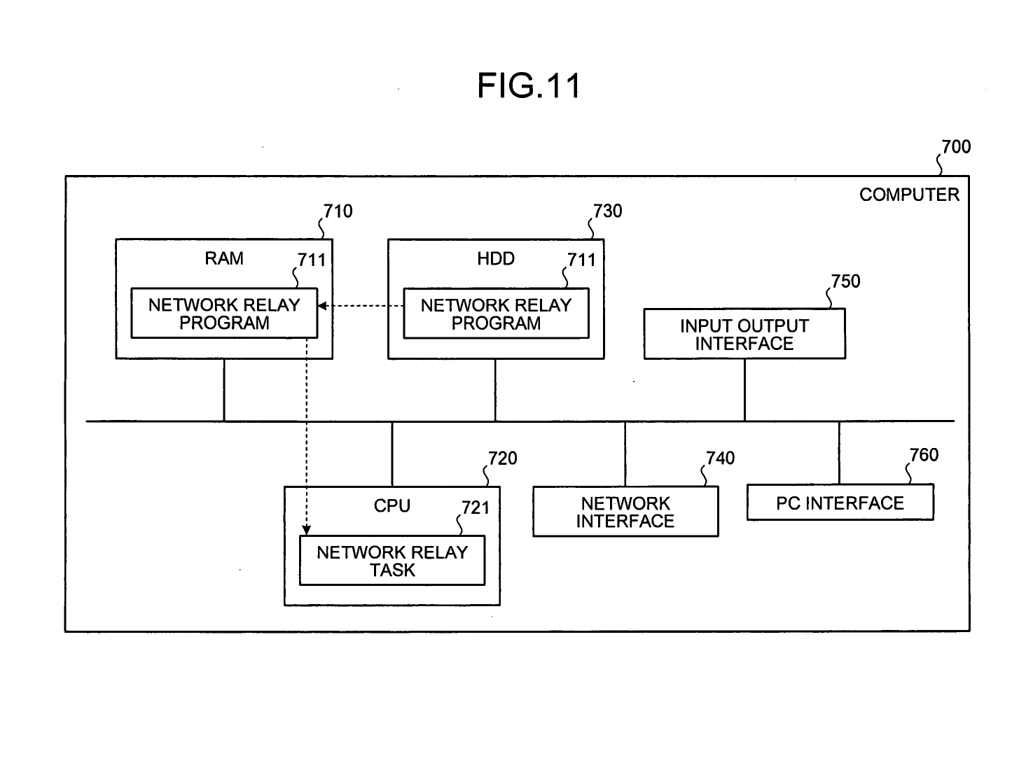

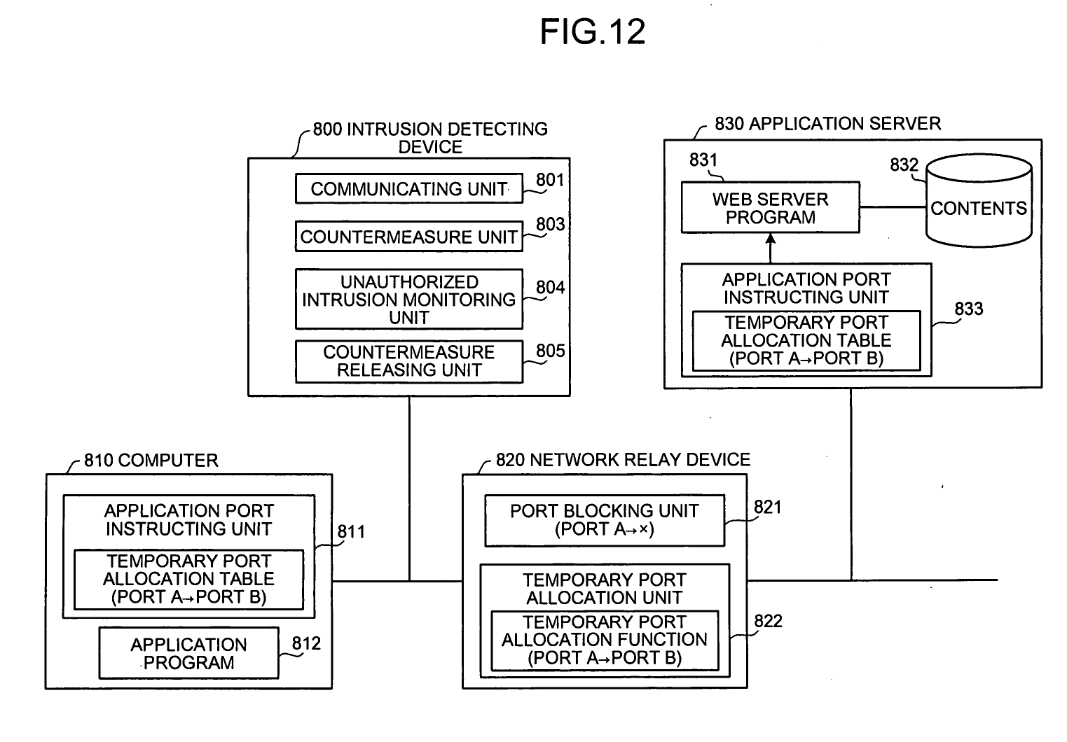

FIG. 11 is a functional block diagram of the computer that executes the network relay program according to the first and the second embodiments. As shown in FIG. 11, a computer 700 includes a Random Access Memory (RAM) 710, a Central Processing Unit (CPU) 720, a Hard Disk Drive (HDD) 730, a network interface 740, an input output interface 750, and a Personal Computer (PC) interface 760.

The RAM 710 stores programs and results during execution of programs. The CPU 720 reads the programs from the RAM 710 and executes the read programs.

The HDD 730 stores programs and data. The network interface 740 is an interface for connecting the computer 700 to the internal network and the external network.

The input output interface 750 is an interface for connecting an input device such as a mouse or a keyboard and a display device. The PC interface 760 is an interface for connecting the computer 700 with a PC.

A network relay program 711 that is executed by the computer 700 is developed on the PC, read from the PC via the PC interface 760, and installed in the computer 700.

The network relay program 711 can also be stored in a database of another computer system that is connected to the computer 700 via the network interface 740, read from the database, and installed in the computer 700.

The installed network relay program 711 is stored in the HDD 730, read by the RAM 710, and executed by the CPU 720 as a network relay task 721.

According to one aspect of the present invention, only communication by an unauthorized program is blocked, thereby enabling other applications that run in an internal computer to continue communicating with an external network even after unauthorized communication by the unauthorized program is detected.

According to another aspect of the present invention, it is possible to reliably implement countermeasures against unauthorized communication.

According to still another aspect of the present invention, it is possible to deal with unauthorized communication without affecting the other application programs.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that records thereon a computer program that relays communication between an internal network and an external network, the computer program including instructions which, when executed, cause a computer to execute:
fetching an unauthorized communication identifier used for communication by an unauthorized program that transmits unauthorized data from the internal network to the external network; and
controlling relay of data communication between the internal network and the external network based on fetched unauthorized communication identifier, after transmission of unauthorized data by the unauthorized program has been detected.

2. The recording medium according to claim 1, wherein
the unauthorized program uses an unauthorized destination identifier to identify a destination;
an internal computer connected to the internal network uses a substitute destination identifier instead of the unauthorized destination identifier to transmit data to the external network, after transmission of unauthorized data by the unauthorized program has been detected;
the act of fetching includes fetching the unauthorized destination identifier and the substitute destination identifier; and
the act of controlling includes transmitting data from the internal network to the external network, by replacing the substitute destination identifier with the unauthorized destination identifier as destination, and transmitting data from the external network to the internal network, by replacing the unauthorized destination identifier with the substitute destination identifier as source.

3. The recording medium according to claim 2, further making the computer execute:
transmitting the unauthorized destination identifier and the substitute destination identifier to the internal computer; and
instructing the internal computer to use the substitute destination identifier instead of the unauthorized destination identifier to transmit data to the external network; and wherein
the act of fetching includes fetching the unauthorized destination identifier and the substitute destination identifier that are transmitted to the internal computer during the act of instructing.

4. The recording medium according to claim 3, further making the computer execute:
detecting unauthorized data transmitted by the unauthorized program from the internal network to the external network;
specifying the unauthorized destination identifier; and
determining a substitute destination identifier to be used instead of specified unauthorized destination identifier for transmitting data to the external network; and wherein
the act of instructing includes transmitting determined substitute destination identifier to the internal computer along with the unauthorized destination identifier.

5. The recording medium according to claim 1, wherein
the act of fetching includes fetching an unauthorized destination identifier that is used as destination, and an unauthorized source identifier that is used as source by the unauthorized program; and
the act of controlling includes controlling data communication between the internal network and the external network, based on a combination of fetched unauthorized destination identifier and fetched unauthorized source identifier.

6. The recording medium according to claim 5, further making the computer execute:
detecting unauthorized data transmitted by the unauthorized program from the internal network to the external network; and
specifying the unauthorized-destination identifier and an unauthorized source identifier; and wherein
the act of fetching includes fetching specified unauthorized destination identifier and specified unauthorized source identifier.

7. A network relay method that relays communication between an internal network and an external network, comprising:
fetching an unauthorized communication identifier used for communication by an unauthorized program that transmits unauthorized data from the internal network to the external network; and
controlling relay of data communication between the internal network and the external network based on fetched unauthorized communication identifier, after transmission of unauthorized data by the unauthorized program has been detected.

8. The network relay method according to claim 7, wherein
the unauthorized program uses an unauthorized destination identifier to identify a destination;
an internal computer connected to the internal network uses a substitute destination identifier instead of the unauthorized destination identifier to transmit data to the external network, after transmission of unauthorized data by the unauthorized program has been detected;
the act of fetching includes fetching the unauthorized destination identifier and the substitute destination identifier; and
the act of controlling includes transmitting data from the internal network to the external network, by replacing the substitute destination identifier with the unauthorized destination identifier as destination, and transmitting data from the external network to the internal network, by replacing the unauthorized destination identifier with the substitute destination identifier as source.

9. The network relay method according to claim 8, further comprising:
transmitting the unauthorized destination identifier and the substitute destination identifier to the internal computer; and
instructing the internal computer to use the substitute destination identifier instead of the unauthorized destination identifier to transmit data to the external network; and wherein
the act of fetching includes fetching the unauthorized destination identifier and the substitute destination identifier that are transmitted to the internal computer during the act of instructing.

10. The network relay method according to claim 9, further comprising:
detecting unauthorized data transmitted by the unauthorized program from the internal network to the external network;
specifying the unauthorized destination identifier; and
determining a substitute destination identifier to be used instead of specified unauthorized destination identifier for transmitting data to the external network; and wherein
the act of instructing includes transmitting determined substitute destination identifier to the internal computer along with the unauthorized destination identifier.

11. The network relay method according to claim 7, wherein
the act of fetching includes fetching an unauthorized destination identifier that is used as destination, and an unauthorized source identifier that is used as source by the unauthorized program; and
the act of controlling includes controlling data communication between the internal network and the external network, based on a combination of fetched unauthorized destination identifier and fetched unauthorized source identifier.

12. The network relay method according to claim 11, further comprising:
detecting unauthorized data transmitted by the unauthorized program from the internal network to the external network; and
specifying the unauthorized destination identifier and an unauthorized source identifier; and wherein
the act of fetching includes fetching specified unauthorized destination identifier and specified unauthorized source identifier.

13. A network relay device that relays communication between an internal network and an external network, comprising:
an unauthorized communication identifier fetching unit that fetches an unauthorized communication identifier used for communication by an unauthorized program that transmits unauthorized data from the internal network to the external network; and
a communication data relay controller that controls relay of data communication between the internal network and the external network based on fetched unauthorized communication identifier, after transmission of unauthorized data by the unauthorized program has been detected.

14. The network relay device according to claim 13, wherein
the unauthorized program uses an unauthorized destination identifier to identify a destination;
an internal computer connected to the internal network uses a substitute destination identifier instead of the unauthorized destination identifier to transmit data to the external network, after transmission of unauthorized data by the unauthorized program has been detected;
the unauthorized communication identifier fetching unit fetches the unauthorized destination identifier and the substitute destination identifier; and
the communication data relay controller transmits data from the internal network to the external network, by replacing the substitute destination identifier with the unauthorized destination identifier as destination, and transmits data from the external network to the internal network, by replacing the unauthorized destination identifier with the substitute destination identifier as source.

15. The network relay device according to claim 14, further comprising:
an instructing unit that transmits the unauthorized destination identifier and the substitute destination identifier to the internal computer, and instructs the internal computer to use the substitute destination identifier instead of the unauthorized destination identifier to transmit data to the external network; and wherein
the unauthorized communication identifier fetching unit fetches the unauthorized destination identifier and the substitute destination identifier that are transmitted by the instructing unit to the internal computer.

16. The network relay device according to claim 15, further comprising:
an unauthorized destination identifier specifying unit that detects unauthorized data transmitted by the unauthorized program from the internal network to the external network, and specifies the unauthorized destination identifier;
a substitute destination identifier determining unit that determines a substitute destination identifier to be used instead of specified unauthorized destination identifier for transmitting data to the external network; and wherein
the instructing unit transmits determined substitute destination identifier to the internal computer along with the unauthorized destination identifier.

17. The network relay device according to claim 13, wherein
the unauthorized communication identifier fetching unit fetches an unauthorized destination identifier that is used as destination, and an unauthorized source identifier that is used as source by the unauthorized program; and
the communication data relay controller controls data communication between the internal network and the external network, based on a combination of fetched unauthorized destination identifier and fetched unauthorized source identifier.
